(19) United States
(12) Patent Application Publication
(10) Pub. No.: US 2005/0289036 A1
(43) Pub. Date: Dec. 29, 2005

(54) Method for securitizing retail lease assets

(75) Inventors: Lawrence B. LaCombe JR., Southlake, TX (US); Robert L. Schwartz, Farmington Hills, MI (US); Fredrick L. Feldkamp, Chicago, IL (US); Elizabeth A. Raymond, Chicago, IL (US); Robert N. Deitz, Gerrards Cross (GB); William A. Levy, Deerfield, IL (US); Richard V. Kent SR., Grosse Pointe Woods, MI (US); Robert L. Straub, Rochester Hills, MI (US); Nancy L. Bugg, Etibicoke (CA); Christine A. Ondrick, Okemos, MI (US); Cynthia A. Ranzilla, New York, NY (US); Gregory A. Kruszewski, Royal Oak, MI (US)

Correspondence Address: FOLEY & LARDNER, 777 EAST WISCONSIN AVENUE, SUITE 3800, MILWAUKEE, WI, 53202-5308, US

(73) Assignee: General Motors Corporation

(21) Appl. No.: 11/216,780

(22) Filed: Aug. 31, 2005

Related U.S. Application Data
(63) Continuation of application No. 09/718,749, filed on Nov. 22, 2000.

(51) Int. Cl. G06F 17/60

(52) U.S. Cl. 705/35

(57) ABSTRACT

The present invention provides a new form of financial instrument for securitization of retail automotive and light truck lease assets. The instrument is supported by secured notes that are separately and independently secured by a first priority perfected lien on each related vehicle and lease (to protect the investment entity which creates securities sold to investors 27 and, thereby, the investors 27). The method of the present invention for creating the financial instrument includes creating a leasing company. The leasing company then acquires leases from dealers. In one embodiment of the present invention, termination value guarantees on the leases can be obtained. A financial asset is issued to fund the acquisition of the leases. In one embodiment of the present invention, a nominee titleholder and a registered lien are created on each leased vehicle. The financial asset is transferred to a securities-issuing entity. A security backed by pools of the financial assets is offered via a registered public offering or an exempt private placement transaction.

### CROSS-REFERENCE TO RELATED APPLICATIONS

This application claims the benefit under 35 U.S.C. § 120 of U.S. application Ser. No. 09/718,749, filed Nov. 22, 2000 and entitled “Method for Securitizing Retail Lease Assets,” the entire content of which is hereby incorporated by reference.

### FIELD OF INVENTION

The present invention relates to creation and financing of retail vehicle lease assets.

### BACKGROUND OF INVENTION

Manufacturers of personal consumer transportation vehicles (“Vehicle Manufacturers”), for example, automobiles and light trucks (“Vehicles”) sell their Vehicles to dealers (“Vehicle Dealers”): The Vehicle Dealers market these Vehicles to consumers through various marketing techniques such as showroom display and local advertising. When consumers obtain Vehicles from Vehicle Dealers, the consumer generally pays only a small part of the amount paid to the dealer. The major part of the purchase price is usually paid by a separate financial concern (the “the Vehicle Financier”).

Several Vehicle Manufacturers have affiliated Vehicle Financiers that provide Vehicle financing through consumer loans and consumer leases. Vehicle Financiers also include financial concerns having no affiliation with a Vehicle Manufacturer.

Prior to the 1990s, most Vehicle financing was primarily in the form of a loan or instalment sale contract, pursuant to which consumers would either purchase Vehicles with money loaned by a Vehicle Financier or purchase Vehicles under obligations to pay the Vehicle Dealers over time. In the latter case, Vehicle Financiers acquire the installment sale contract from the Vehicle Dealers. The Vehicle provides security to the Vehicle Financier for that loan or obligation under the instalment sales contract. The loans or contracts became assets of the Vehicle Financier, and the Vehicle Financier would either finance the retention of these assets by borrowing and investing their equity capital or selling these assets to investors. Prior to the 1990s, consumer leases (where a Vehicle Financier acquires a Vehicle leased to a consumer) represented a relatively small portion of the assets of Vehicle Financiers.

As Vehicle Manufacturers have met consumer demands for greater quality and content in Vehicles, as well as emissions standards and other regulatory compliance requirements, the initial cost and long-term value of Vehicles have risen considerably in the past two decades. These trends have influenced consumers and manufacturers to seek alternatives to traditional loan financing for consumer sales. This has led many consumers and Vehicle Financiers to prefer leasing and, therefore, to a significant growth of the consumer lease portfolios of Vehicle Financiers.

In a typical consumer lease transaction, the Vehicle is owned originally by the Vehicle Dealer and leased to the consumer. The Vehicle is then sold by the Vehicle Dealer to the Dealer Financier, subject to the consumer lease. This allows the consumer to use the Vehicle in exchange for paying monthly lease payments, while retaining for the Vehicle Financier the right to the Vehicle at lease termination.

Leasing allows all affected parties to take advantage of much higher projected resale values for newer used Vehicles at the time when the Vehicle lease ends and the consumer is shopping for a new Vehicle. In addition, the Vehicle Financier enjoys certain tax benefits that may help to offset financial risks of Vehicle ownership.

The growth of lease portfolios at Vehicle Financiers has led to increased need for financial structures that allow Vehicle Financiers to finance and to transfer the liquidity and investment risks of these portfolios.

Several known financial instruments are used by Vehicle Financiers to fund and to transfer Vehicle sale transactions. However, because of unique aspects of Vehicle leases, many of the financing alternatives which support Vehicle sales are not available on economically viable terms to support lease portfolios.

In traditional loan financing of Vehicle sales, the Vehicle Financier owns a consumer financial instrument (a debt) secured by a lien on the related Vehicle. Such financial instruments are readily transferable and, as a matter of law, the rights of the Vehicle Financier to the collateral value of the Vehicle transfer to the purchaser of the instrument. In the case of a lease, however, the Vehicle Financier owns the Vehicle and a contract to receive rent as the Vehicle is used. Since rent is paid in exchange for use, the lease is an executory contract, not a financial instrument. The Vehicle Financier's ownership of the Vehicle does not transfer to a purchaser of the lease without retitling the Vehicle.

With respect to very large items of equipment, lease financiers use procedures that involve ownership transfers to facilitate portfolio financing. An example is an equipment trust note, such as is used to finance leased aircraft and locomotives. Equipment trust notes are debt instruments (financial assets) which are created at the time the lessor (the equipment trust) purchases the leased equipment. The notes are secured by the leases and equipment held in the related equipment trusts.

These equipment trust notes typically provide recourse only to the assets of an equipment trust (the lease and lease assets) and constitute financial assets in the hands of their holders. To create this instrument, the equipment and lease are transferred to a trust that issues equipment trust notes secured by a lien on the equipment and on the lease.

Equipment trust notes are supported solely by lease revenues and security interests in the related leases and leased equipment. They are in the legal form of non-recourse notes. When issued in public offerings or private placements, equipment trust notes are financial assets supported by the equipment and the substantive credit of lessees that provide cash flow that supports the notes. The security interest in the related leased equipment may also be foreclosed upon when the cash flow support fails. Owners of equipment trust notes, having a security interest in the lease assets, possess a first priority right to the lease assets ahead of, for example, income tax claims and judgment liens subsequently filed against the trust which owns the asset.

Programs of the prior art to find consumer Vehicle lease transactions created trusts, but issued only equity interests in the trust, initially to the Vehicle Financier that formed the trust, and later to a trust that would issue securities representing interests therein to the public. This provides an investment in the legal form of ownership interests in a pool of leases and Vehicles. Since no debt is created with respect to each lease and Vehicle, no enforceable lien is, therefore, able to be noted on the related title of each Vehicle.

As a result, prior art Vehicle lease “securitizations” produced equity-like risks that were atypical for investment in financial assets. Security holders obtain ownership interests in the assets and are not protected by a direct lien on the equipment. Therefore, other creditors can obtain prior rights to the Vehicles. That is not the case for investments in other high quality financial instruments offered by Vehicle Financiers, such as equipment trust notes, mortgages, retail automotive receivables, home equity loans, and wholesale dealer floor plan loans.

Without creating a financial asset at the time of lease inception and acquisition, the nature of retail Vehicle leasing has made it difficult to effectively “sell” the rights of a lessor. This is partly attributable to accounting rules developed at a time when “tax shelter” structures dominated the leasing market. Under Generally Accepted Accounting Principles (GAAP), operating lease assets are particularly difficult to “sell” when the seller seeks to retain risks and rewards of residual values (as is required to retain the tax benefits of leasing referred to above). Yet, it is desirable for the Vehicle Manufacturer and the Vehicle Financier to retain these risks and rewards so they can manage residuals associated with a large lease portfolio to achieve scale economies. Thus, economic goals for the securitization of Vehicle operating leases have conflicted with historic accounting practice.

In some measure, these lease accounting rules represent a logical and expected consequence of the nature of lease assets. Receivables, particularly those that are represented by notes or similar instruments, are readily saleable by endorsement in the ordinary course (even with recourse) because the seller has no future obligation to the obligor. The situation of a lessor, however, is quite different in that a lease is traditionally viewed as a bilateral executory contract, comprised of mutual rights and obligations and legally implies a future performance obligation of the lessor (even though such obligations are minimal, in practice).

Under traditional rules, rights of a lessor to receive lease cash flow are generally recognized as transferable. Obligations, however, which are presumed to exist in every lease, are not recognized as transferable without consent. Since rights and obligations exist in a single asset, there are natural expectations that the contract cannot be deemed “sold” while integral duties and residual rights are retained. A lessor was traditionally presumed incapable of merely transferring obligations he or she owed to the lessee, absent lessee consent.

For many years titling issues alone proved sufficient to discourage lessors from selling motor Vehicle operating leases. To effect a sale, lessors had to undergo a relatively expensive process of retitling each Vehicle. Generally, the cost of retitling made it cheaper to borrow. Recent development of titling trusts that preclude the need for retitling when a financial transfer occurs (by placing leases and Vehicles in a trust from the date of inception) has lessened the expensive process of retitling. Prior art structures for titling trusts, however, continue to present a number of features that are not desirable from the perspective of potential investors.

Since the prior art structures do not involve the creation of debt secured by each separate Vehicle and do not create residual guarantees concurrently with lease inception, they do not overcome accounting issues and subsequent creditor risks. These undesirable features, and the enhancements that are used to overcome them, limit the utility of those prior art securitization structures.

Difficulties with lease assignment for prior art structures are compounded by the interlocking impact of certificate of title laws, the U.S. Bankruptcy Code and laws that impose liability on lessors by virtue of mere asset ownership (“Vicarious Liability”). To be recognized as the party entitled to benefits of Vehicle residual values in the event of bankruptcy, a financial investor or its agent is generally required to be reflected as owner on the certificate of title. If not listed on the title, a lease acquirer faces possible loss of its asset in the event of the seller's bankruptcy. The party named on the title, however, becomes a potential target for Vicarious Liability if the Vehicle is involved in an accident.

When the Vehicles in a pool of leases and Vehicles supporting investment are “owned” by a titling trust and investors are not protected by a higher priority lien, a Vicarious Liability claim in respect of a single Vehicle can result in a superior claim to all pooled assets. This could deny to investors in securities backed by the pool all rights to all Vehicles (and other assets) in the pool as a result of an action affecting only a single lease asset in the pool.

Investors in lease-backed securities of the prior art must, therefore, accept Vicarious Liability (and other judgment and tax lien risks) or the Vehicle Financier must separately insure against this risk, adding a non-economic cost that is not generally associated with passive investment in highly rated securities. This is because (i) leases are executory contracts deemed “cancellable” on the Vehicle Financier insolvency; (ii) Vicarious Liability tort claims expose an entire operating lease pool to the risk of a single negligent lessee; and (iii) judgment lien creditors, federal and state tax liens and liens under ERISA are superior to investors in operating lease assets.

As a result, prior art structures create increased costs to fund lease financing and risks that risk averse investors (wary of exposure to risk factors) will limit the amount of funds available to Vehicle Financiers at a reasonable cost. What would, therefore, be beneficial would be an investment security that assures continuous access to financial markets for the funding of lease assets generated to support leases that, in turn, support Vehicle sales by a Vehicle Manufacturer. The investment security should assure that financial assets can be acquired by a Vehicle Financier to support leasing activities which have independent collectibility, are freely saleable under GAAP and are free of credit risks associated with (i) a Vehicle Manufacturer's manufacturing business, (ii) risks associated with ownership of a pool of lease Vehicles and (iii) Vicarious Liability and other lien risks arising from the ownership and operation of leased Vehicles. The investment security should back the financial instrument by a perfected lien on consumer Vehicle leases, related Vehicles, insurance and other assets, but avoid the risks associated with lease-backed securities of the prior art. Ultimately, such an investment security should provide for favorable means of financing the distribution of Vehicles.

### SUMMARY OF INVENTION

The investment securities of the present invention assure continuous access to financial markets for Vehicle Financiers to fund lease assets generated to support Vehicle sales by a Vehicle Manufacturer. The investment securities of the present invention assure that financial assets can be acquired by a Vehicle Financier which have independent collectibility, are freely saleable under GAAP and are free of credit risks associated with (i) a Vehicle Manufacturer's manufacturing business, (ii) risks associated with ownership of a pool of lease Vehicles and (iii) Vicarious Liability and other lien risks arising from the ownership and operation of leased Vehicles. The investment securities of the present invention back the financial instrument by a perfected lien on consumer Vehicle leases, related Vehicles, insurance and other assets, but avoid the risks associated with lease-backed securities of the prior art. Ultimately, the investment securities of the present invention provide for favorable means of financing the distribution of Vehicles.

The present invention provides a new form of financial instrument for securitization of retail Vehicle lease assets. The instrument is supported by secured notes that are separately and independently secured by a first priority perfected lien on each related Vehicle and lease (to protect the investment entity which creates securities sold to investors and, thereby, the investors). The method of the present invention for creating the financial instrument includes creating a separate leasing entity. The leasing entity then acquires leases from dealers. In one embodiment of the present invention, termination value guarantees on the leases will be obtained to provide coverage at the time of lease inception. A financial asset is issued to fund the acquisition of the leases. In one embodiment of the present invention, a nominee titleholder and a registered lien are created on each leased Vehicle. The financial asset is transferred to a securities-issuing entity. A security backed by pools of the financial assets is offered to investors via a registered public offering or an exempt private placement transaction.

### BRIEF DESCRIPTION OF THE FIGURES

FIG. 1 is a schematic overview of the transaction parties of the securitizing retail lease asset in accordance with the principles of the present invention.

FIG. 2 is a flow-chart of the funds which are utilized to securitize the retail lease asset of FIG. 1.

### DETAILED DESCRIPTION OF THE INVENTION

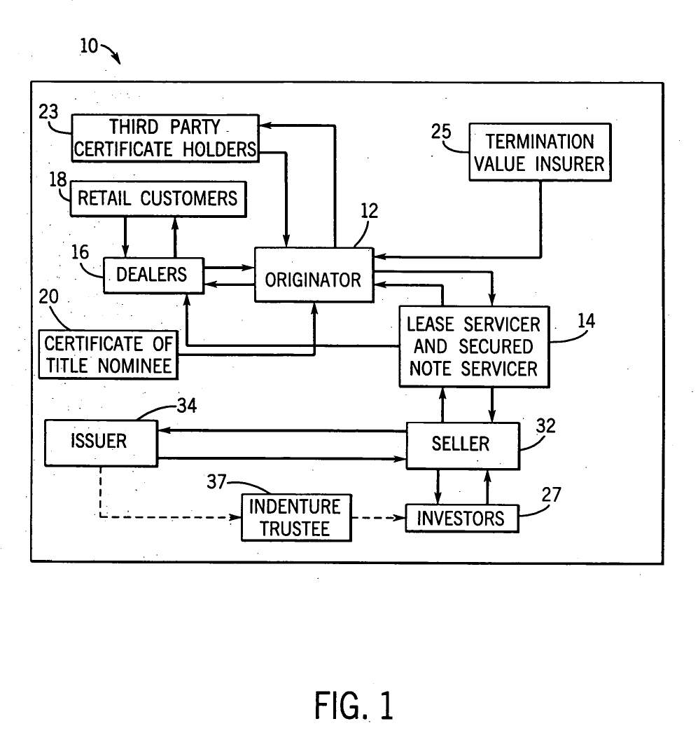

FIG. 1 provides a schematic overview of a securitization of retail lease assets in accordance with the principles of the present invention 10. Initially, an entity will be created to perform as a leasing company (the “Lease Trust”) 12. By the sale of its own securities, the Lease Trust 12 will enjoy financial independence from the Vehicle Manufacturer and the Vehicle Financier 14. The Vehicle Financier 14 will be allocated tax benefits of the Lease Trust 12 under statutorily permitted allocation rules. The Lease Trust 12 will acquire leases from Vehicle Dealers 16 that inventory and sell Vehicles. The Vehicle Dealers 16 will provide Vehicles to retail customers 18 and will arrange a lease transaction to finance the Vehicle. Under existing contracts between the Vehicle Dealer 16 and the Vehicle Financier 14 the Vehicle Dealer 16 acts as the Vehicle Financier's agent, with the Vehicle Financier 14 directing the transfer of the lease to the Lease Trust 12. By contract with the Lease Trust 12, the Vehicle Financier 14 will cause the leases to conform to specific standards to enable the securitized retail lease assets of the present invention. The Lease Trust 12 then arranges for the financing of this lease transfer as described below, in accordance with the principles of the present invention.

The Lease Trust 12 will acquire a lease and Vehicle using funds obtained primarily by borrowing from a Vehicle Financier 14 against the security of each lease and Vehicle. Each borrowing to acquire a new lease and Vehicle will be evidenced by a separate secured note (each, a “Secured Note”) and payable only out of the proceeds of the related lease and Vehicle. Credit enhancements arranged by the Lease Trust 12 will assure, to a very high probability, that each Secured Note will be repaid, in full, when and as it becomes due. The balance of the acquisition price for each Vehicle will be provided by the Lease Trust's 12 equity. Proceeds of each Secured Note will be applied directly toward the acquisition of the related Vehicle from the Vehicle Dealer 14.

The Lease Trust 12 will be the legal, accounting and tax owner of each Vehicle and lease that it acquires. In a preferred embodiment, title to each Vehicle will be registered in the name of a nominee for the Lease Trust 12 and the lien which secures the related Secured Note will be evidenced by appropriate notation (as a first lien) on the certificate of title for the specific Vehicle which secures that Secured Note.

Holders of the Secured Notes will have a first priority security interest, but no legal or beneficial “ownership” interest, in each related lease or Vehicle. In the preferred embodiment, these holders will initially be the Vehicle Financier 14 and ultimately a securitization vehicle (collectively, “Holders”). The rights of Holders of the Secured Notes will be those of a secured lender, and such Holders will have no obligations in respect of other debts of the lessees or the Lease Trust 12. Rights of Holders will be superior to those of the Vehicle owner (the Lease Trust 12) and subject only to normal restrictions applicable to secured creditors. The lien securing each Secured Note will appear on each related Vehicle title, in the same manner as for retail finance contracts involved in financing non-lease consumer Vehicle sales.

The appearance of the lien of each Secured Noteholder on the related title will be in contrast to prior-art lease-finance systems. Prior art lease securitization structures involve transfers of beneficial ownership interests in leases and Vehicles rather than Secured Notes where a lender is noted as a lien-holder upon each title. The only interest that can be made available to investors under the prior art, therefore, does not provide any of the normal protections available to secured creditors with properly recorded first liens.

Except for its related equity investment, the Lease Trust 12 will play no further role in, and will bear no recourse with respect to, each Secured Note. The Lease Trust's 12 right to recover equity will be subordinated to rights of Holders. Thus, the Secured Notes will be non-recourse obligations of the Lease Trust 12. Secured Notes in a pool supporting the securities to be issued will not be cross-defaulted or cross-collateralized.

While the Lease Trust's 12 equity will be subordinate to Secured Notes, both the Lease Trust's 12 equity and the Secured Notes will be each supported by revenues from individual consumer leases, security interests in Vehicles and credit enhancement (which arises at the time the lease is created) under a termination value insurance policy 25 which supports both the rights of Holders and the rights of the Lease Trust 12.

The termination (or “residual”) value insurance policy 25 applies to each lease and lease Vehicle as each transaction is originated and it cannot be cancelled during the term of each Secured Note. In contrast, in prior art lease finance systems residual value insurance originates at the time a securitization occurs, not when the lease is originated. The insurance 25 for the Lease Trust 12 will be sized to provide credit support to each Secured Note and its related Lease Trust 12 equity against any loss due to default or other insufficiency on each Secured Note.

In addition to a diverse portfolio of leases and Vehicles and the insurance coverage 25, the Lease Trust 12 will provide for servicing of the assets under servicing agreements and for designated-purpose reserves. The servicing agreements will include means for assuring both the full extent of required lease residual value guaranty coverage and the most efficient utilization of such coverage by allocating coverage only to the extent required and by obtaining maximum recovery benefits to support future losses. These rights will also be pledged to the benefit of holders of securities that will be backed by the Secured Notes.

Unlike prior art lease structures, investors 27 that invest in securities backed by the Secured Notes will have rights that will not be impacted by the possibility of future judgment creditors of the Lease Trust 12 or by similar liens that would supersede the finance party's priority interest in each related lease and Vehicle. Thus, for example, the Holder of a Secured Note would receive rights to the lease and related Vehicle that will be superior to those of a judgment (or tax) lien creditor of the Lease Trust 12. Isolating the Lease Trust's 12 assets from operating risks associated with the pool of Vehicles, ownership of the Vehicles and of the Vehicle Manufacturer and Vehicle Financier 14 will be an important principle of the present invention.

Each Secured Note will have separate collateral and credit support sufficient to permit its saleability and ratability with no recourse to any other of the Lease Trust's 12 assets. The Lease Trust's 12 equity will be at risk only on a note-by-note basis, and only after exhaustion of all credit enhancements, including termination value (including residual value) insurance 25 and foreclosure proceeds of the related lease and Vehicle. Based on this collateral and the sizing of the termination value insurance 25, the possibility that any Holder of a Secured Note would have to pursue its share of equity will be remote. When Secured Notes are pooled to back securities that will be issued, these protections virtually assure that the ultimate securities will be highly rated and will avoid risk factors associated with prior art.

Any holders of the Lease Trust's 12 equity will be subordinate, in respect of each lease and leased Vehicle, to the rights of Holders of Secured Notes and of securities backed by pools of Secured Notes. Because the Vehicle Manufacturer and the Vehicle Financier 14 have no meaningful equity position in the Lease Trust 12, and because the lien securing each Secured Note is superior to any ERISA lien, ERISA liens will not present the level of concern that is present in prior art structures. Likewise, the lien of each Holder of a Secured Note will be superior to other tax liens and to any judgment lien (relating to Vicarious Liability or otherwise).

The interest rate on each Secured Note will be fixed at inception with respect to a particular retail customer 18 Vehicle lease transaction based on rates generally applicable to similar consumer transactions at the time of issuance. The payment schedule on each Secured Note will be predetermined to match the expected cash flow generated by each related customer 18 transaction.

No proceeds of any Secured Note will be available to the Lease Trust 12 for use in respect of any business other than the particular consumer lease transaction for which the Secured Note was originated. All funds of the Lease Trust 12 that will be applied to a particular transaction will be paid at the time the Secured Note will be originated. No assets, equity or business interest of the Lease Trust 12 (other than the assets and specific equity used to support each transaction at the time the Secured Note will be originated) will be available to Secured Noteholders. Thus, investors 27 in securities backed by the Secured Notes will be not affected by changes in the operation of the Lease Trust 12 as a business enterprise.

Although the likelihood of a Lease Trust 12 bankruptcy will be remote, the Lease Trust 12 will not be a special-purchase or bankruptcy-remote entity. It will be an operating equipment lessor that will be licensed in numerous states. The primary source of financial strength of the Lease Trust 12 will be the Lease Trust's 12 portfolio of leases and Vehicles. The Lease Trust's 12 assets will be dispersed geographically and its cash flows will be readily determinable based on statistically significant empirical and actuarial analyses. These cash flows will comprise the primary financial support for all securities of the Lease Trust 12 and all securities backed by Secured Notes.

In the preferred embodiment of the invention, the most likely initial investor in the Secured Notes will be a Vehicle Financier 14. Alternatively, the initial investors in the Secured Notes can be third party certificateholders 23. The purpose for purchasing Secured Notes will be to acquire financial assets that will be more readily saleable than direct ownership interests in (or beneficial interests in) leased Vehicles. The ultimate Holders of interests in Secured Notes will be investors 27 in securities backed by pools of Secured Notes. Because the Lease Trust 12 invention creates financial instruments (the Secured Notes), the securitization Vehicles customarily used for sale of Vehicle loans will be available to Vehicle Financiers 14 that use the Lease Trust 12 invention.

A separate, special-purpose nominee trust will be established that will hold the bare legal title for each Vehicle to be owned and leased by the Lease Trust 12 (the “Title Trust”) 20. The Title Trust 20 is named as owner of title on each original certificate of title (the lien securing the Secured Note is also noted thereon) by virtue of the application made when each Vehicle Dealer 16 applies for the issuance of a title to the Vehicle with each affected state's motor vehicle registration office. This protects both the Lease Trust 12 and all Holders of the Secured Notes and holders of securities backed by such Secured Notes.

The ultimate financial asset created by the invention is an asset-backed security backed by the Secured Notes that the Vehicle Financier 14 has acquired from the Lease Trust 12 and places with an issuing entity that issues the asset-backed securities (the “Securities Product”). Each separate issue of the Securities Product will be backed by a separate pool of Secured Notes and various enhancements. In order to support the sale of the Securities Product, the Secured Notes may be discounted from their respective consumer market rates to the current investment market interest rates at the date of the offering and otherwise enhanced to address investment criteria.

The Securities Product will be sold either via registered public offerings in compliance with registration and prospectus requirements or exempt private placement transactions; sale of the Securities Product will not constitute a distribution of the Secured Notes themselves.

In an alternative embodiment, an entity will be formed to purchase a portfolio of Secured Notes that the Vehicle Financier 14 has accumulated over time (the “Seller”) 32. The Seller 32 will deposit those financial assets into a trust (the “Issuer Trust”) 34. The Issuer Trust 34 will be the issuer of the Securities Product. In an alternative embodiment, the Issuer Trust can make a pledge of Secured Notes, to an indenture trustee 37. The Seller 32 will sign the registration statement as depositor. The Vehicle Financier 14 will serve as the servicer of the securities sold, the Secured Notes and the collateral backing the Secured Notes.

All material disclosures typical for securitization of financial assets will be included in the registration statement for the Securities Product. These will include the relevant pool data relating to the Secured Notes backing both the particular Securities Product and all Secured Notes then outstanding. Information will be provided relating to the Vehicle Financier 14 (as seller of the Secured Notes, as servicer of the Secured Notes and the lease collateral for those Secured Notes, and as underwriting agent for the Secured Note collateral). In addition, information relating to credit enhancement—primarily the termination value insurance policy 25—will also be disclosed.

The Vehicle Financier 14 will conspicuously disclose the fact that each Secured Note will be not supported by any assets of the Lease Trust 12 other than those assets specifically pledged as collateral. Such a disclosure will properly imply a very low level of correlation between this investment and investments made in the Lease Trust 12 directly.

Each Issuer Trust 34 will be a separate issuer. Each Secured Note held by an Issuer Trust 34 will be separately secured by the related retail consumer lease and by a recorded lien on the related Vehicle. Each such Secured Note will also be protected by the termination value insurance 25 against all loss, including loss due to inadequate residual value of the related vehicle.

As seller of the Secured Notes, the Vehicle Financier 14 will make customary representations and warranties regarding underwriting and servicing of the Secured Notes. The Vehicle Financier 14 will be obligated to repurchase a Secured Note where there will be a material failure to comply with those representations and warranties.

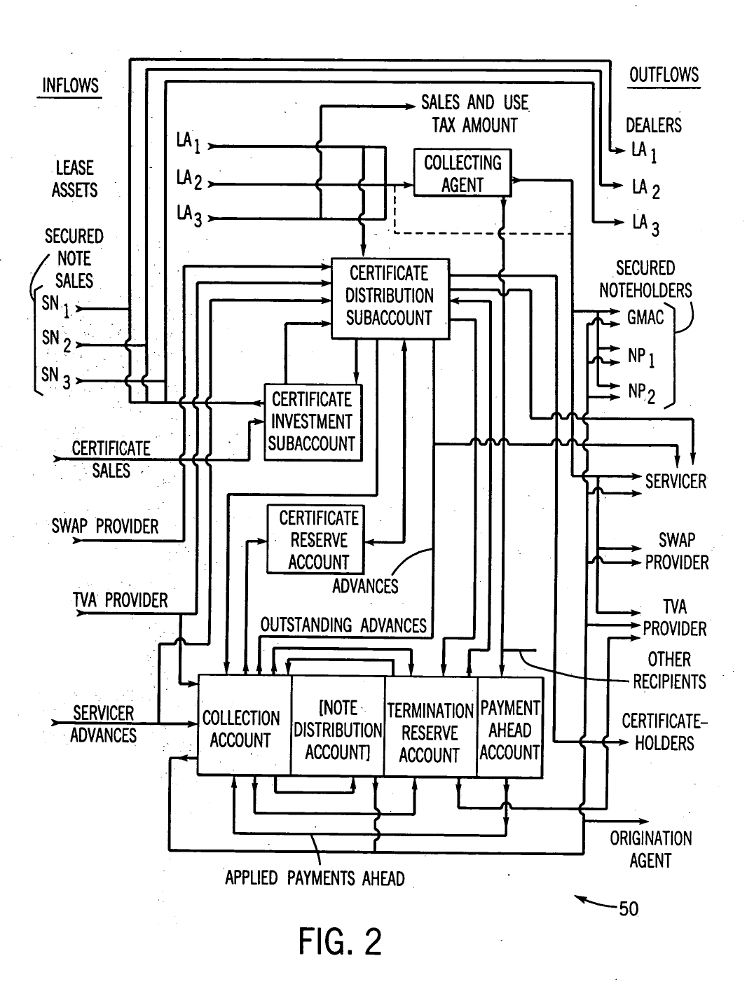

Referring now to FIG. 2, a flow-chart of funds into and out of the Lease Trust 12 to securitize the retail lease assets is seen. The inflows include lease assets (LA), Secured Note sales (SN), certificate sales (CS), payments from a swap provider (SP), payments from a termination value agreement provider (TVA), and servicer advances (SA). The outflow entities include Vehicle Dealers, the Secured Noteholders (SH), the servicer (S), the swap provider (SP), the termination value agreement provider (TVA), certificateholders (CH), and the underwriting agent (OA).

Lease assets are provided to a Collecting Agent. In addition, a portion of the lease assets is provided for sales and use tax and a portion of the lease assets is provided to a Certificate Distribution Subaccount. The Collecting Agent provides funds to the Secured Noteholders (SH), the servicer (S), the swap provider (SP) and the termination value agreement provider (TVA). The Collecting Agent further provides cash flow to a Payment Ahead Account, and to other recipients. In addition, a portion of the payment on lease assets (LA) is provided directly to the Secured Noteholders (SH), the servicer (S), the swap provider (SP), and the termination value agreement provider (TVA).

Funds from certificate sales are provided to a Certificate Investment Subaccount. The Secured Note sales (SN) are provided to the Vehicle Dealers 16 as a portion of the acquisition price. In the preferred embodiment, an additional portion of the acquisition price is provided from the Certificate Investment Subaccount to the Vehicle Dealers. Funds also are provided from the Certificate Investment Subaccount to the Certificate Distribution Subaccount. Funds also are provided from the Certificate Distribution Subaccount to the Certificate Investment Subaccount. Additional funds are provided to the Certificate Distribution Subaccount from the swap provider (SP), the termination value agreement provider (TVA) and from the servicer advances (SA).

The termination value agreement provider (TVA) and the servicer advances (SA) provide further funds to a Collection Account. Further funds are provided to the Collection Account from the Certificate Distribution Subaccount, a Termination Reserve Account, and a Payment Ahead Account. Funds from the Collection Account are provided to a Certificate Reserve Account, to the Termination Reserve Account, and to a Note Distribution Account. Funds are transferred between the Certificate Reserve Account and the Certificate Distribution Subaccount.

Funds from both the Collection Account and from the Certificate Distribution Subaccount are provided to the servicer (S) as a return of advances. Funds both from the Collection Account and from the Note Distribution Account are provided to the underwriting agent (OA), the termination value agreement provider (TVA), the swap provider (SP), the servicer (S), and to the Secured Noteholders (SH).

Funds from the Termination Reserve Account are provided to the termination value agreement provider (TVA). Funds from the Termination Reserve Account also are provided to the Certificate Distribution Subaccount. Funds from the Certificate Distribution Subaccount are provided to the Termination Reserve Account. Funds from the Certificate Distribution Subaccount also are provided to the certificateholders (CH). In addition to the funds from both the Collection Account and from the Certificate Distribution Subaccount provided to the servicer (S) as advances, funds from the Certificate Distribution Subaccount are provided to the servicer (S).

In the preferred embodiment, the Secured Noteholders create and offer the Securities Product either via registered public offerings or exempt private placements, as previously described, and funds payable to Secured Noteholders will be paid to the trust or other entity which will, in turn, pay funds to the holders of the Securities Product.

While the invention has been described with specific embodiments, other alternatives, modifications and variations will be apparent to those skilled in the art. Accordingly, it will be intended to include all such alternatives, modifications and variations set forth within the spirit and scope of the appended claims.

1. A method for securitizing retail lease assets comprising:
creating a leasing company;
acquiring leases from dealers into the leasing company;
issuing a financial asset to fund such acquisition;
securing the financial asset;
transferring the financial asset to a securities-issuing entity; and
offering a security backed by pools of the financial assets.

2. The method for securitizing retail lease assets of claim 1 further including the step of creating a nominee titleholder and a registered lien on each leased vehicle.

3. The method for securitizing retail lease assets of claim 1 further including the step of financially supporting the leasing company separate from manufacturer of the vehicle and the financier of the vehicle.

4. The method for securitizing retail lease assets of claim 1 further wherein the step of acquiring leases from dealers into the lease company includes funding the lease acquisition primarily by borrowing against the security of first priority perfected security interests in each lease and vehicle.

5. The method for securitizing retail lease assets of claim 1 further including securing the vehicle residual value included within each financial asset at the time of inception by a termination value (including residual value) insurance policy.

6. The method for securitizing retail lease assets of claim 1 further wherein the step of offering a security backed by the financial asset further includes offering the security via a registered public offering.

7. The method for securitizing retail lease assets of claim 1 further wherein the step of offering a security backed by the financial asset further includes offering the security via an exempt private placement transaction.

8. A security comprised of the following attributes:
the security being backed by a financial asset;
the financial asset being issued by a company having a portfolio of leases;
the leases having been acquired from dealers; and
each lease and financial asset pertaining to a particular vehicle.

9. The security of claim 8 further wherein the company having a portfolio of leases is financially supported separate from the manufacturer of the vehicle and the financier of the vehicle.

10. The security of claim 8 further wherein the lease acquisition is funded primarily by borrowing against the security of first priority perfected security interests in each lease and vehicle.

11. The security of claim 8 further wherein the financial asset is secured by a termination value (including residual value) insurance policy at the time of lease inception.

12. The security of claim 8 further wherein the financial asset is supporting the financial asset by credit enhancement under a termination value (residual value) insurance policy which takes effect at the time of lease inception.

13. The security of claim 8 further wherein the security is offered via a registered public offering.

14. The security of claim 8 further wherein the security is offered via an exempt private placement transaction.

15. A method for securitizing retail lease assets comprising:
creating a leasing company which acquires leases from dealers;
obtaining termination value guarantees;
issuing a financial asset to fund the acquisition of the leases;
transferring the financial asset to a securities-issuing entity; and
offering a security backed by pools of the financial assets.

16. The method for securitizing retail lease assets of claim 15 further including the step of creating a nominee titleholder and a registered lien on each leased vehicle.

17. The method for securitizing retail lease assets of claim 15 further including the step of financially supporting the leasing company separate from manufacturer of the vehicle and the financier of the vehicle.

18. The method for securitizing retail lease assets of claim 15 further wherein the step of acquiring leases from dealers includes funding the lease acquisition primarily by borrowing against the security of first priority perfected security interests in each lease and vehicle.

19. The method for securitizing retail lease assets of claim 15 further wherein the step of offering a security backed by the financial asset further includes offering the security via a registered public offering.

20. The method for securitizing retail lease assets of claim 15 further wherein the step of offering a security backed by the financial asset further includes offering the security via an exempt private placement transaction.
